(19) United States
(12) Patent Application Publication
(10) Pub. No.: US 2015/0169854 A1
(43) Pub. Date: Jun. 18, 2015

(54) CAPTURING COGNITIVE FINGERPRINTS FROM KEYSTROKE DYNAMICS FOR ACTIVE AUTHENTICATION

(71) Applicant: IOWA STATE UNIVERSITY RESEARCH FOUNDATION, INC., Ames, IA (US)

(72) Inventors: Jien Morris Chang, Ames, IA (US); Kuan-Hsing Ho, Ames, IA (US); Chi-Chen Fang, Ames, IA (US)

(73) Assignee: IOWA STATE UNIVERSITY RESEARCH FOUNDATION, INC., Ames, IA (US)

(21) Appl. No.: 14/107,774

(22) Filed: Dec. 16, 2013

(51) Int. Cl. G06F 21/31

(52) U.S. Cl. CPC G06F 21/31

(57) ABSTRACT

A method for authenticating identity of a user using keystrokes of the user includes receiving as input the keystrokes made by the user, extracting cognitive typing rhythm from the keystroke to provide features, wherein each of the features is a sequence of digraphs of a specific word, and providing active authentication using the features where the user is a legitimate user. A system for authenticating identity of a user using keystrokes of the user includes a plurality of stored profiles stored on a non-transitory computer readable medium, a sensor module for acquiring the keystrokes of the user to provide biometric data, a feature extraction module to process the biometric data and extract a feature set to represent the biometric data, a matching module to compare feature from the feature set with the stored profiles using a classifier to generate matching scores, a decision module configured to use the matching scores from multiple classifiers to verify a user's identity.

### FIELD OF THE INVENTION

The present invention relates to authentication using keystroke dynamics. More particularly, but not exclusively, the present invention relates to using cognitive typing rhythm to provide authentication.

### BACKGROUND OF THE INVENTION

Conventional authentication systems verify a user only during initial login. Active authentication performs verification continuously as long as the session remains active. This work focuses on using behavioral biometrics, extracted from keystroke dynamics, as “something a user is” for active authentication. This scheme performs continual verification in the background, requires no additional hardware devices and is invisible to users.

Keystroke dynamics, the detailed timing information of keystrokes when using a keyboard, has been studied for the past three decades. The typical keystroke interval time is expressed as the time between typing two characters, which is also known as a digraph. The keystroke rhythms of a user are distinct enough from person to person such that they can be used as biometrics to identify people. However, it has been generally considered much less reliable than physical biometrics such as fingerprints. The main challenge is the presence of within-user variability.

Due to within-user variability of interval times among identical keystrokes, most past efforts have focused on verification techniques that can manage such variability. For example, a method called Degree of Disorder (DoD) [1, 2] was proposed to cope with the time variation issues. It argued that while the keystroke typing durations usually vary between each sample, the order of the timing tends to be consistent. It suggested that the distance of the order between two keystroke patterns can be used to measure the similarity.

A recent paper [3] provided a comprehensive survey on biometric authentication using keystroke dynamics. This survey paper classified research papers based on their features extraction methods, feature subset selection methods and classification methods.

Most of the systems described in this survey were based on typing rhythm of short sample texts, which is dominated by the physical characteristics of users and too brief to capture a “cognitive fingerprint.” In the current keystroke authentication commercial market, some products combine the timing information of the password with password-based access control to generate the hardened password [4, 5, 6].

Despite these advances what is needed are improved methods and systems for providing authentication.

### SUMMARY OF THE INVENTION

Therefore, it is a primary object, feature or advantage to improve over the state of the art.

It is a further object, feature, or advantage of the present invention to take into account cognitive factors involved in typing particular words.

It is a still further object, feature, or advantage of the present invention to allow for active and continuous authentication.

One or more of these and/or other objects, features, or advantages of the present invention will become apparent from the description. No single embodiment need exhibit each or any of these objects, features, or advantages and it is contemplated that different embodiments may have different objects, features, or advantages.

According to one aspect, a method for authenticating identity of a user using keystrokes of the user is provided. The method includes receiving as input the keystrokes made by the user, extracting cognitive typing rhythm from the keystroke to provide features, wherein each of the features is a sequence of digraphs of a specific word, and providing active authentication using the features where the user is a legitimate user.

According to another aspect, a system for authenticating identity of a user using keystrokes of the user includes a plurality of stored profiles stored on a non-transitory computer readable medium, a sensor module for acquiring the keystrokes of the user to provide biometric data, a feature extraction module to process the biometric data and extract a feature set to represent the biometric data, and a matching module to compare feature from the feature set with the stored profiles using a classifier to generate matching scores. The system further includes a decision module configured to use the matching scores from multiple classifiers to verify a user's identity. Each of the features comprises a sequence of digraphs of a specific word so as to capture cognitive factors manifesting as natural pauses in typing of the specific word.

According to another methodology, a method for authenticating identity of a user using keystrokes of the user on a keyboard is provided. The method includes receiving as input the keystrokes made by the user on the keyboard, extracting cognitive typing rhythm from the keystrokes to provide features, wherein each of the features is a sequence of digraphs of a specific word, building classifiers for each of the features using one or more stored profiles, and using a computing device to provide active authentication using the features where the user is a legitimate user by scoring a plurality of the classifiers and determining whether the user is to be authenticated or not based on the scoring.

### BRIEF DESCRIPTION OF THE DRAWINGS

FIG. 1A illustrates a digraph “re” from the same user.

FIG. 1B illustrates two users typed the same word “really”.

FIGS. 2A and 2B illustrate Training and cross-validation in machine learning graphs.

FIGS. 3A and 3B illustrate experiment results graphs.

FIG. 4 is an overview of a methodology.

FIG. 5 is an overview of a system.

### DETAILED DESCRIPTION OF THE PREFERRED EMBODIMENTS

A biometric-based active authentication system and related methods are described herein. This system allows for continuously monitoring and analyzing various keyboard behavior performed by the user. The method used allows for extracting the features from keystroke dynamics that contain cognitive factors, resulting in cognitive fingerprints. Each feature is a sequence of digraphs from a specific word. This method is driven by the hypothesis that a cognitive factor can affect the typing rhythm of a specific word. Cognitive factors have been largely ignored in the keystroke dynamics studies of the past three decades. The system allows for: (1) search for cognitive fingerprints; (2) building of an authentication system with machine learning techniques; and (3) results from a large scale experiment.

### Searching for Cognitive Fingerprints

Physical biometrics rely on physical characteristics such as fingerprints or retinal patterns. The behavioral biometric of keystroke dynamics must incorporate cognitive fingerprints to advance the field, but the cognitive fingerprint does not have a specific definition. The inventors hypothesize that natural pauses (delays between typing characters in words) are caused by cognitive factors (e.g., spelling an unfamiliar word or after certain syllables) [7, 8, 9, 10, 11], which are unique among individuals. Thus, a cognitive factor can affect the typing rhythm of a specific word. In this research, each feature is represented by a unique cognitive typing rhythm (CTR) which contains the sequence of digraphs from a specific word. Such features include natural pauses among its timing information (e.g., digraphs) and could be used as a cognitive fingerprint. Conventional keystroke dynamics does not distinguish timing information between different words and only considers a collection of digraphs (e.g., tri-graphs or N-graphs). Cognitive factors, thus, have been ignored.

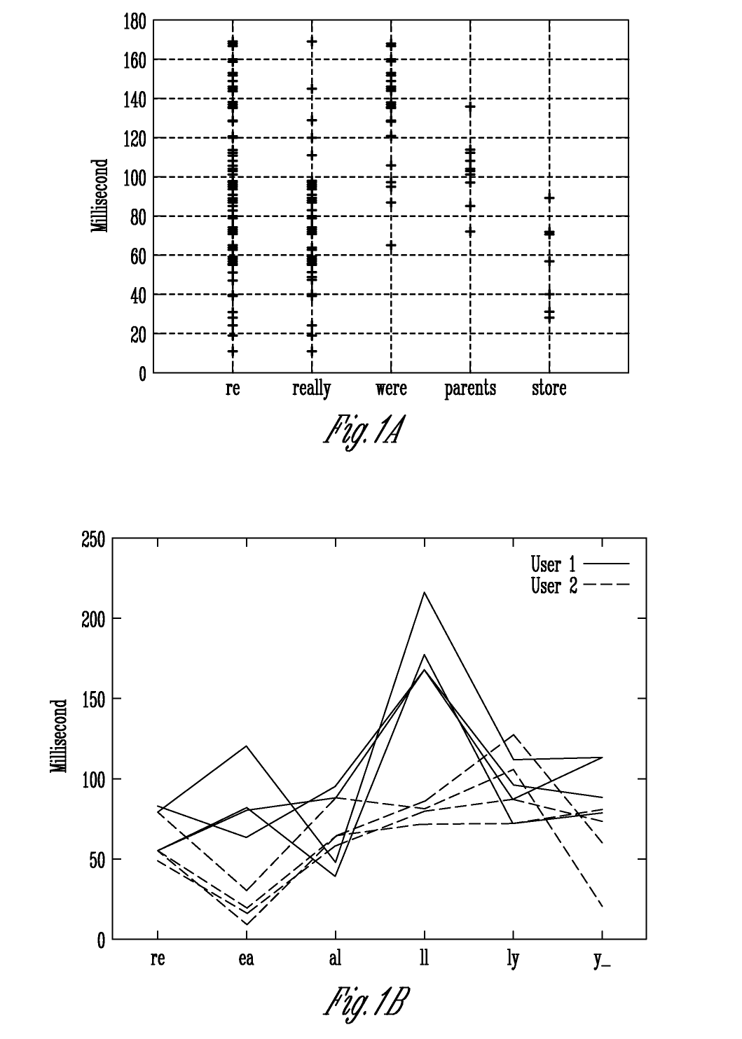

As shown in FIGS. 1A and 1B, there is a collection of digraphs (“re”) observed from the same user. One might think the collection of digraphs represent part of a keystroke rhythm. However, upon closer examination of each collection of digraphs, these digraphs are clustered around different words that contain the digraphs. For example, for the collection of digraphs “re”, one can separate these digraphs according to four different words (i.e., really, were, parents, and store). This shows that examining digraphs in isolation might result in missing some important information related to specific words. This observation confirms our hypothesis: a cognitive factor can affect the typing rhythm of a specific word. Thus, one can extract CPR from keystroke dynamics and use them as features (cognitive fingerprints) for active authentication. Each feature is a sequence of digraphs of a specific word (instead of a collection of digraphs). For each legitimate user, one can collect samples of each feature and, then, build a classifier for that feature during the training phase of machine learning.

### Building Authentication System With Machine Learning Techniques

Two examples of different authentication systems have been developed based on two different machine learning techniques. The first one uses off-the-shelf SVM (support vector machine) library [12] while the second one employs an in-house developed library based on KRR (Kernel Ridge Regression) [13]. These libraries are used to build each classifier during the training phase. While it is not possible to know the patterns of all imposters, one may use patterns from the legitimate user and some known imposters to build each classifier and expect that it can detect any potential imposter within a reasonable probability. This is a two-class (legitimate user vs. imposters) classification approach in machine learning. One may build a trained profile with multiple classifiers for each legitimate user. During the testing phase (i.e., authentication), a set of testing data is given to the trained profile for verification. Each classifier under testing yields a matching score between the testing dataset and trained file. The final decision (accept or reject) is based on a sum of scores fusion method.

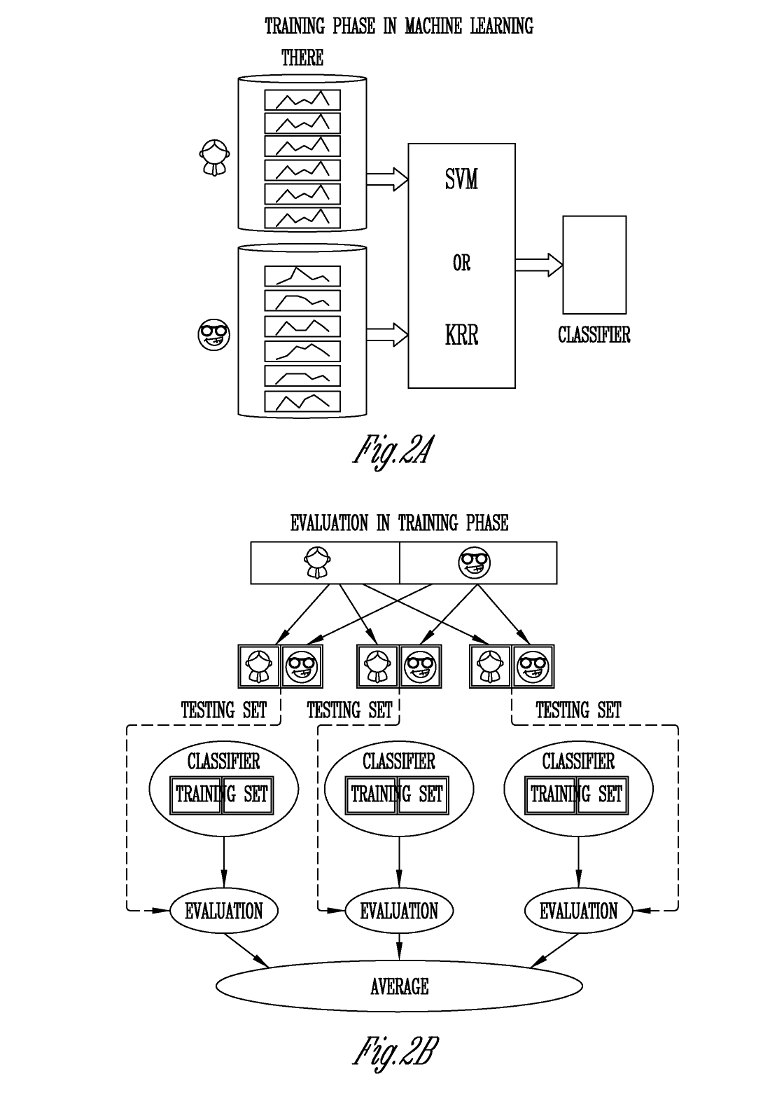

Other than differing basic machine learning libraries, the two systems share the same feature selection and fusion method. In the fusion method, one may evaluate each classifier to determine the confidence level of its decision. Such evaluation is conducted during the training phase with datasets from each legitimate user and imposters. The basic idea is illustrated in FIGS. 2A and 2B. A subset of the dataset is used to train a temporary classifier. The remaining dataset is used to test the classifier. Such testing will be repeated multiple times to ensure a good estimation. This technique is called cross-validation (a.k.a. rotation estimation).

From results of these tests, one can estimate the probabilities of true acceptance (Pₜₐ) and false acceptance (P_{fa}) of the classifier. For example, after the testing with dataset from legitimate user,

there are N acceptances out of M samples, Pₜₐ is N/M. The confidence of decision (Wₐ) on acceptance is expressed as the ratio of Pₜₐ to P_{fa}. The confidence of decision on rejection (Wᵣ) is expressed as the ratio of the probability of true rejection (1-P_{fa}) to the probability of false rejection (1-Pₜₐ).

After the training, in the trained profile, there are Wₐ and Wᵣ for each classifier. During the testing phase, each classifier generates a decision (acceptance or rejection). Either Wₐ or Wᵣ will be applied to this decision. The final decision is based on the sum of scores of all involved classifiers.

### A Large Scale Experiment at Iowa State University

A web-based software system was developed to collect the keystroke dynamics of individuals in large scale testing at Iowa State University. This web-based system provided three simulated user environments: typing short sentences, writing short essays, and browsing web pages. The users' cognitive fingerprints were stored in a database for further analyses. Machine learning techniques were used to perform pattern recognition to authenticate users.

During November and December of 2012, email invitations were sent to 36,000 members of the ISU community. There were 1,977 participants completed two segments that each lasted about 30-minutes, and resulted in about 900 words for each participant for each segment. In addition, 983 participants (out of the 1,977) completed another segment of approximately 30-minutes in length, in which about 1,200 words were collected for each participant. For the experiment, 983 individual profiles (trained files) were developed. Each profile was trained under two-class classification in which one legitimate user had 2,100 collected words and the imposter training set was based on collected words from other 982 known participants. Each profile was tested with the data of the 1,977 participants (testing dataset of 900 words per participant).

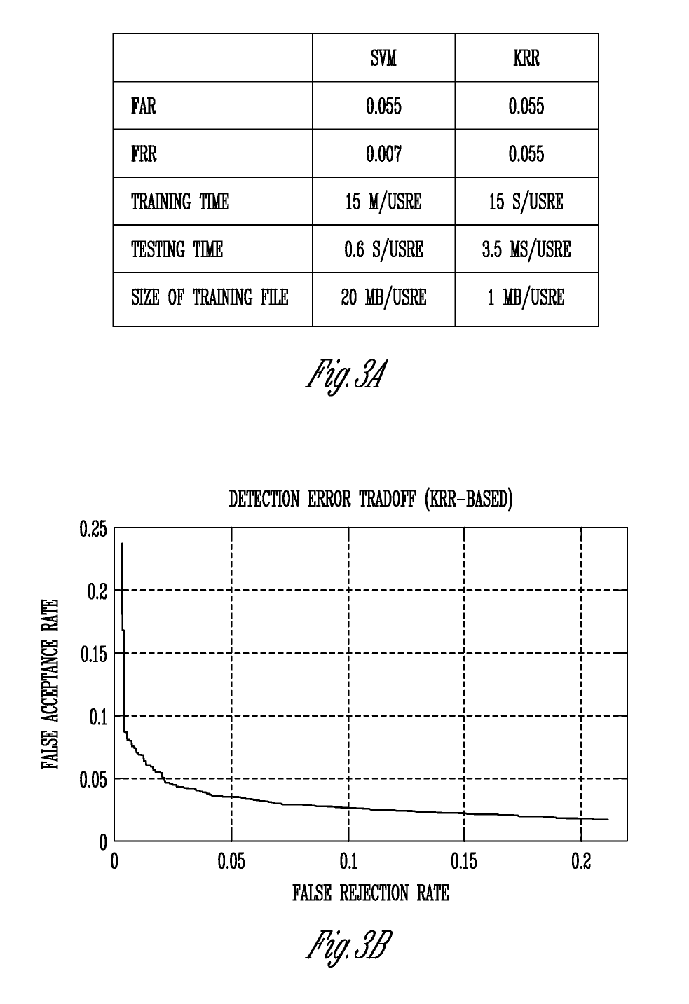

The experiment results are presented in FIG. 3 where the performance comparison of two verification systems is summarized in FIG. 3A, and the DET (Detection Error Tradeoff) chart from KRR-based system is given in FIG. 3B. In summary, the proposed scheme is effective for authentication and has been verified through a large-scale dataset.

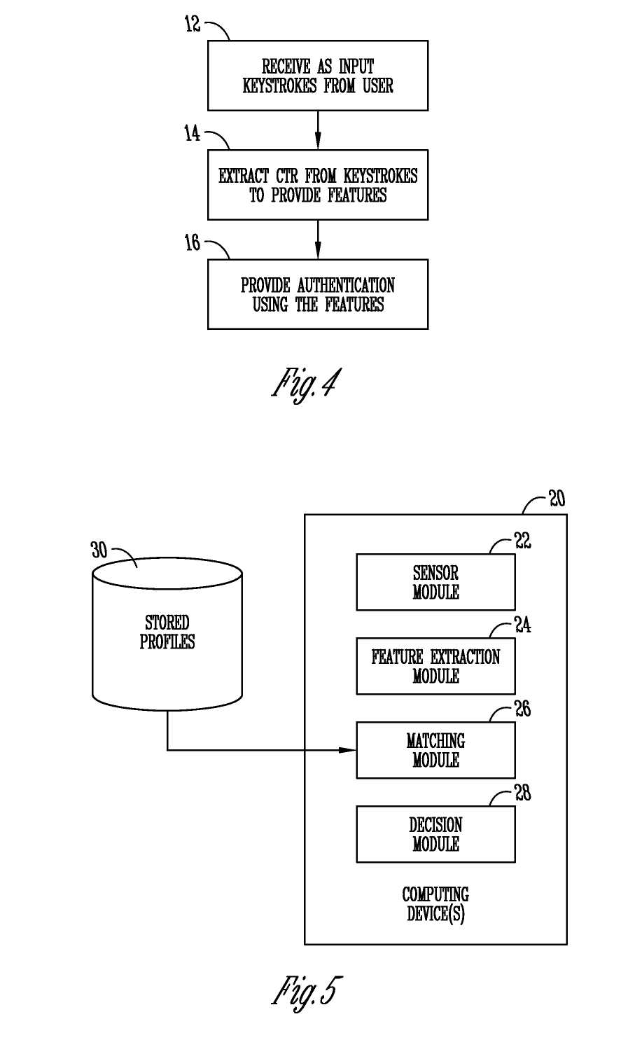

FIG. 4 is an overview of a methodology. In step 12 keystrokes are received from a user as input. In step 14, cognitive factors such as cognitive typing rhythm information is extracted from the keystrokes to provide features. Each of the features is preferably a sequence of digraphs of a specific word. In step 16, authentication is provided using the features.

FIG. 5 is an overview of a system. One or more computing devices 20 are used. A sensor module 22 may be used for a sensor module 22 for acquiring the keystrokes of the user to provide biometric data. A feature extraction module 34 may be used to process the biometric data and extract a feature set to represent the biometric data. A matching module 26 may be used to compare a feature from the feature set with the stored profiles within a database 30 such as by using a classifier to generate matching scores. A decision module 28 may be configured to use the matching scores from multiple classifiers to verify a user's identity. Each of the features preferably includes a sequence of digraphs of a specific word so as to capture cognitive factors manifesting as natural pauses in typing of the specific word.

Various systems and methods for authenticating identify of a user through using keystrokes have been disclosed. It is to be understood that these methods and systems may be used in different ways to authenticate users at the beginning of a session, periodically or randomly throughout a session, or continuously throughout a session. In addition, it is to be understood that the systems and methods may be implemented in through various types of hardware configurations including locally or remotely. It is also contemplated that the cognitive factors methodology described herein can be used regardless of whether the keystrokes are on conventional keyboards, soft keys on a touch screen display, or other types of devices. Thus, the present invention contemplates and encompasses numerous options, variations, and alternatives.

### REFERENCES

The following references are hereby incorporated by reference in their entireties.
[1] F. Bergadano et al., “User authentication through keystroke dynamics”. ACM Trans. Inf. Syst. Secur., vol. 5, pp. 367-397, November 2002.
[2] D. Gunetti and C. Picardi, “Keystroke analysis of free text,” ACM Trans. Inf. Syst. Security, vol. 8, no. 3, pp. 312-347, August 2005.
[3] M. Kaman et al., “Biometric personal authentication using keystroke dynamics: A review,” Appl. Soft Computing, vol. 11, no. 2, pp. 1565-1573, March 2011.
[4] F. Monrose et. al., “Password hardening based on keystroke dynamics,” in Proceedings of the 6th ACM Conference on Computer and Communications Security, Singapore, November 1999, pp. 73-82.
[5] AdmitOne Security, http://www.biopassword.com/index.asp
[6] ID Control, http://www.idcontrol.com/
[7] C. M. Levy and S. Ransdell, “Writing signatures,” in The Science of Writing: Theories, Methods, Individual Differences, and Applications, C. M. Levy and S. Ransdell, Eds. Mahwah, N.J.: Lawrence Erlbaum, 1996, pp. 149-162.

[8] D. McCutchen, “A capacity theory of writing: Working memory in composition,” Educational Psychology Review, vol. 8, no. 3, pp. 299-325, September 1996.
[9] D. McCutchen, “Knowledge, processing, and working memory: Implications for a theory of writing,” Educational Psychologist, vol. 35, no. 1, pp. 13-23, 2000.
[10] T. Olive, “Working memory in writing: Empirical evidence from the dual-task technique,” European Psychologist, vol. 9, no. 1, pp. 32-42, December 2004.
[11] T. Olive et al., “Verbal, visual, and spatial working memory demands during text composition,” Applied Psycholinguistics, vol. 29, no. 4, pp. 669-687, October 2008.
[12] C.-C. Chang and C.-J. Lin, “LIBSVM: A library for support vector machines,” ACM Transactions on Intelligent Syst. and Technology, vol. 2, no. 3, article no. 27, April 2011
[13] S. Y. Kung, “Kernel Methods and Machine Learning,” Cambridge University Press, 2013.

What is claimed is:

1. A method for authenticating identity of a user using keystrokes of the user, the method having steps comprising:
receiving as input the keystrokes made by the user;
extracting cognitive typing rhythm from the keystrokes to provide features, wherein each of the features is a sequence of digraphs of a specific word; and
providing active authentication using the features where the user is a legitimate user.

2. The method of claim 1 further comprising building classifiers for each of the features and using the classifiers in the active authentication.

3. The method of claim 2 wherein building the classifiers comprises building the classifiers for a set of legitimate users and a set of imposters.

4. The method of claim 2 wherein the active authentication provides for comparing each of the features with stored profiles.

5. The method of claim 4 wherein matching scores from multiple classifiers are used in providing the active authentication.

6. The method of claim 1 wherein the step of receiving as input the keystrokes made by the user comprises receiving as input into a web-based tool the keystrokes made by the user.

7. The method of claim 1 wherein each of the keystrokes is made on a keyboard.

8. A system for authenticating identity of a user using keystrokes of the user, the system comprising:
a plurality of stored profiles stored on a non-transitory computer readable medium;
a sensor module for acquiring the keystrokes of the user to provide biometric data;
a feature extraction module to process the biometric data and extract a feature set to represent the biometric data;
a matching module to compare feature from the feature set with the stored profiles using a classifier to generate matching scores;
a decision module configured to use the matching scores from multiple classifiers to verify a user's identity; and
wherein each of the features comprises a sequence of digraphs of a specific word so as to capture cognitive factors manifesting as natural pauses in typing of the specific word.

9. The system of claim 8 wherein the sensor module uses a web-based tool to acquire the keystrokes of the user.

10. A method for authenticating identity of a user using keystrokes of the user on a keyboard, the method having steps comprising:
receiving as input the keystrokes made by the user on the keyboard;
extracting cognitive typing rhythm from the keystrokes to provide features, wherein each of the features is a sequence of digraphs of a specific word;
building classifiers for each of the features using one or more stored profiles;
using a computing device to provide active authentication using the features where the user is a legitimate user by scoring a plurality of the classifiers and determining whether the user is to be authenticated or not based on the scoring.

11. The method of claim 10 wherein the step of receiving as input the keystrokes made by the user comprises receiving as input into a web-based tool the keystrokes made by the user.
